(19) United States
(12) Patent Application Publication
(10) Pub. No.: US 2013/0208454 A1
(43) Pub. Date: Aug. 15, 2013

(54) LIGHTING DEVICE HAVING MULTIPLE LIGHT CHAMBERS

(71) Applicant: Chi Gon Chen, Guang Zhou (CN)

(72) Inventor: Chi Gon Chen, Guang Zhou (CN)

(73) Assignee: International Development LLC, Roanoke, TX (US)

(21) Appl. No.: 13/745,998

(22) Filed: Jan. 21, 2013

Related U.S. Application Data
(60) Provisional application No. 61/598,174, filed on Feb. 13, 2012.

(51) Int. Cl. F21S 9/03

(52) U.S. Cl. CPC F21S 9/035
USPC 362/183; 362/244

(57) ABSTRACT

A lighting device comprises a circuit housing is disposed between the upper and lower light chambers. An upper lamp is provided for directing light above the circuit housing, and a lower lamp is provided for directing light below the circuit housing. The lighting device includes battery connections for allowing at least one rechargeable battery to provide electrical power the control circuitry. The lighting device also includes a solar panel above the circuit housing for receiving ambient light and recharging the battery.

The present disclosure relates to luminaires, particularly luminaires suitable for outdoor use, including luminaires that comprise a solar power system.

### BACKGROUND

Solar lighting fixtures such as the lighting device 50 shown in FIG. 5 are known that include a solar panel 52 for recharging a battery (not shown), which in turn provides power to a light element 54 such as a light emitting diode (LED). The light element 54 is housed within a light chamber that is laterally enclosed by a lens 56, which allows the lighting device 50 to emit light laterally and downwardly. The light chamber is covered by a circuit housing 58 that supports the solar panel 52. Positioning the solar panel 52 on top of the lighting device 50 is desirable for allowing the solar panel 52 to receive enough ambient light (e.g., sunlight) to allow for recharging the battery. However, the solar panel 52 and housing 58 block light from the light element 54, preventing light from being emitted upwardly, i.e., from an upper side of the lighting device 50. This imparts considerable limitations on design configurations of the lighting device 50 and the effective usefulness of light emitted by such a solar lighting device.

### SUMMARY

A lighting device according to some aspects of the present disclosure can comprise a lower lens that allows at least a portion of impinging light to pass therethrough and an upper lens that allows at least a portion of impinging light to pass therethrough. The lighting device can also include a circuit housing disposed between the upper lens and the lower lens such that a lower light chamber is at least partially defined by the circuit housing and the lower lens, and an upper light chamber is at least partially defined by the circuit housing and the upper lens. Control circuitry can be at least partially disposed within the circuit housing. An upper lamp can be electrically connected to the control circuitry for directing light into the upper chamber, and a lower lamp can be electrically connected to the control circuitry for directing light into the lower chamber. A solar panel can be exposed to the upper light chamber so as to receive light passing through the upper lens.

A lighting device according to other aspects of the present disclosure can comprise a circuit housing that includes an upper housing shell and a lower housing shell and control circuitry at least partially disposed within the circuit housing. An upper lamp can be electrically connected to the control circuitry for directing light above the upper housing shell, and a lower lamp can be electrically connected to the control circuitry for directing light below the lower housing shell. A solar panel can be supported by the upper housing shell. The control circuitry can turn on the upper and lower lamps when light received by the solar panel is below a threshold switch-on value, and turn off the upper and lower lamps when light received by the solar panel is above a threshold switch-off value. The upper lamp is configured such that light emitted from the upper lamp and received by the solar panel is below the threshold switch-off value.

### BRIEF DESCRIPTION OF THE DRAWINGS

Features, aspects, and embodiments of the inventions are described in conjunction with the attached drawings, in which:

FIG. 1 is a side view of a lighting device according to the present disclosure;

FIGS. 2A-2D show respective embodiments of the lighting device shown in FIG. 1;

FIG. 3 shows an exploded view of an embodiment of the light fixture shown in FIG. 1;

FIG. 4 shows partial section view of the light fixture shown in FIG. 1; and

FIG. 5 shows a conventional solar lighting device.

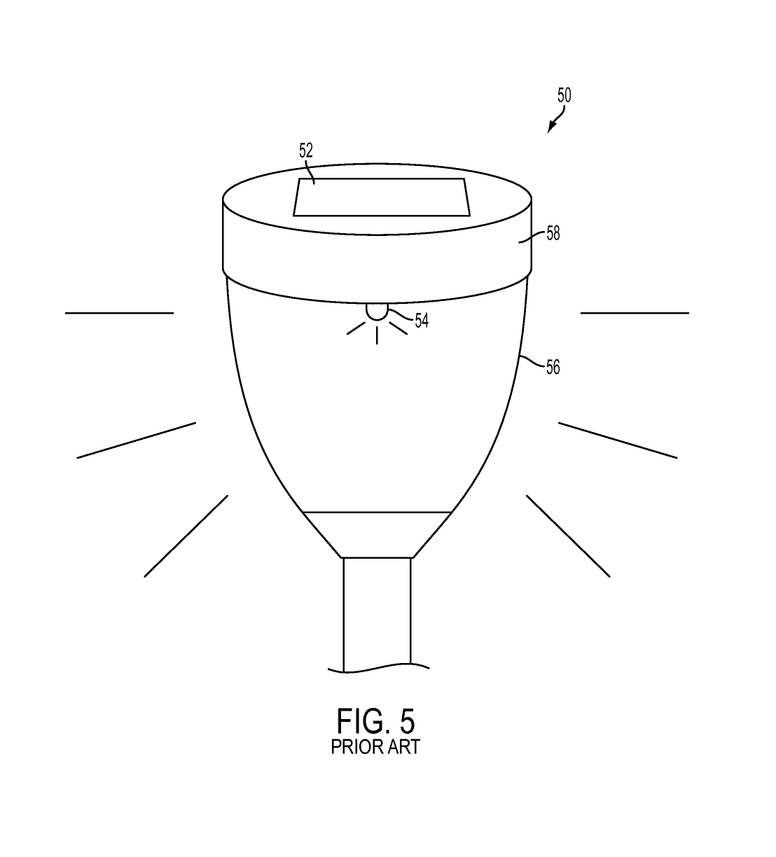

### DETAILED DESCRIPTION

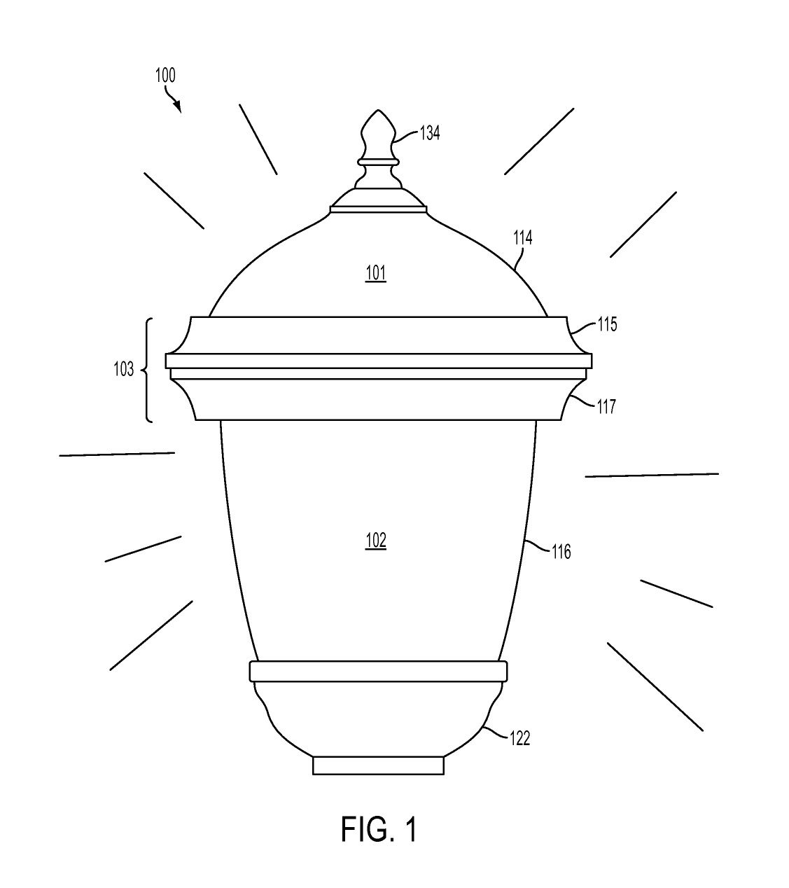

FIG. 1 shows a side view of a lighting device 100 according to the present disclosure. The lighting device 100 incudes an upper light chamber 101 and a lower light chamber 102. The upper light chamber 101 is at least partially enclosed by an upper lens 114. The lower light chamber 102 is at least partially enclosed by a lower lens 116.

The upper light chamber 101 and the lower light chamber 102 are separated by a circuit housing 103. In some embodiments, the circuit housing 103 can include one or both of an upper bezel 115 and a lower bezel 117 that serve as easily-interchangeable decorative elements.

Other optional elements shown in FIG. 1 include upper pinnacle 134 and lower collar 122. Upper pinnacle 134 can be omitted in some embodiments, in which case the upper lens 114 can extend over the portion of the upper light chamber 101 otherwise covered by the upper pinnacle 134 Likewise, lower collar 122 can be omitted in some embodiments, in which case the lower lens 116 can extend over the portion of the lower light chamber 102 otherwise covered by the lower collar 122.

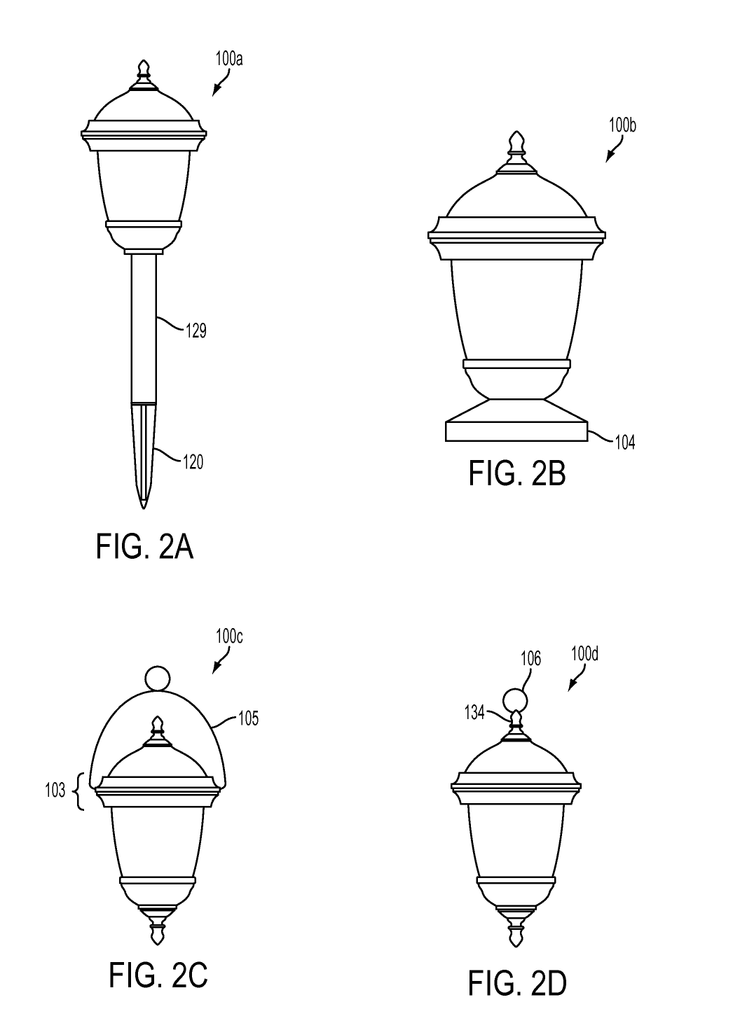

FIGS. 2A-2D show respective embodiments of the lighting device 100 shown in FIG. 1. In FIG. 2A, the lighting device 100a is configured as a garden light and can include a pole 129 and a ground stake 120. In FIG. 2B, the lighting device 100b can include a base 104 for supporting the lighting device 100b on a surface or for allowing to lighting device 100b to be secured to a post or the like. In FIG. 2C, the lighting device 100c can be supported via a hanger 105 that is attached to the circuit housing 103. In FIG. 2D, the lighting device 100d can be supported via a hanger 106 that is attached to the upper pinnacle 134. Still further embodiments can include versions of the lighting device 100 configured as wall-mounted light fixtures.

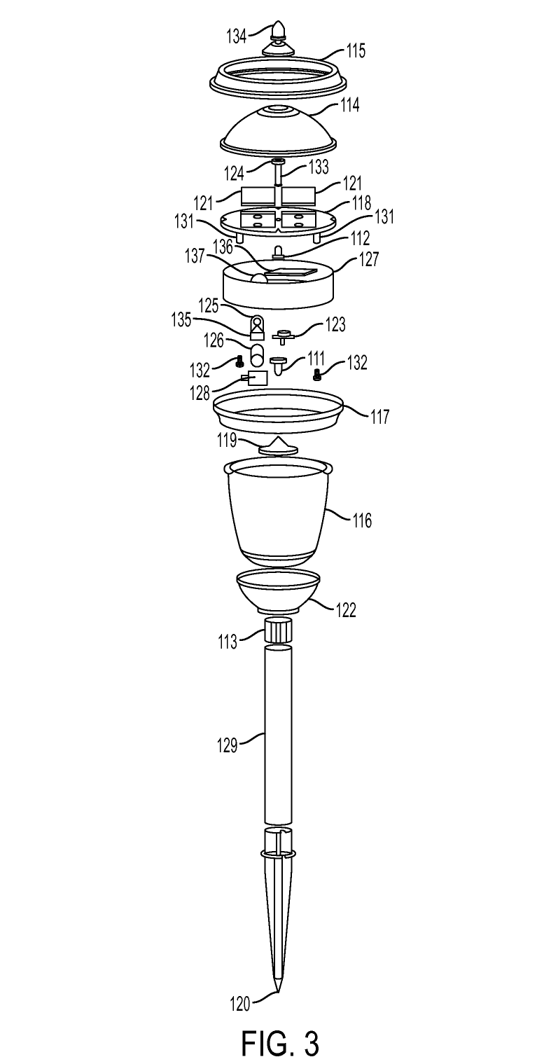

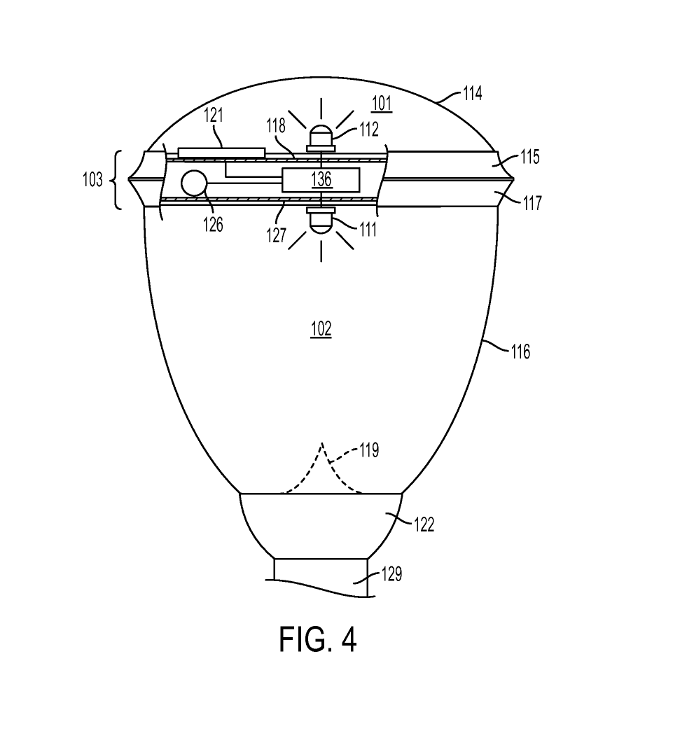

FIG. 3 shows an exploded view of an embodiment of the lighting device 100a and FIG. 4 shows a partial sectional view of the lighting device 100a. The description of FIGS. 3 and 4 generally applies equally to other embodiments, the main exception being where the pole 129 and ground stake 120 are described.

Referring to FIGS. 3 and 4, the lighting device 100a includes a lower lamp 111 and an upper lamp 112. The lamps 111 and 112 preferably each include one or more light emitting diodes (LEDs), however, other types of lamps can be used. The lower lamp 111 is operable to illuminate the lower light chamber 102, and the upper lamp 112 is operable to illuminate the upper light chamber 101.

The upper lens 114 can comprise glass and/or plastic and allows at least a portion of light emitted by the upper lamp 112 to pass therethrough. Likewise, the lower lens 116 can also comprise glass and/or plastic and allows at least a portion of light emitted by the lower lamp 111 to pass therethrough. The upper lens 114 also allows ambient light, such as sunlight, to pass into the upper light chamber 101 and onto one or more solar panels 121 disposed on an upper surface of the circuit housing 103. In alternative embodiments, the upper lens 114 and/or lower lens 116 can be omitted or comprise a grating, such as a decorative metal, ceramic, or plastic grating, in place of or adjacent to the lens 114 and/or 116.

The circuit housing 103 is disposed between the upper light chamber 101 and the lower light chamber 102. The circuit housing 103 comprises an upper housing shell 118 and a lower housing shell 127. The upper housing shell 118 and lower housing shell 127 can be assembled by installing screws 132 into internally-threaded posts 131, or by other fastening means, which can include fasteners and/or adhesives. The upper housing shell 118 and/or the lower housing shell 127 can be formed of plastic and/or metal and can be at least substantially opaque. The upper housing shell 118 and lower housing shell 127 can be assembled together to define a chamber within the circuit housing 103 where control circuitry 136 can be disposed. This allows control circuitry 136 to be hidden from view. The upper housing shell 118 can include a hole through which the upper lamp 112 and/or wiring to the upper lamp 112 can extend. The lower housing shell 127 can include a hole through which the lower lamp 111 and/or wiring to the lower lamp 111 can extend.

Control circuitry 136 can be disposed within the circuit housing. The control circuitry 136 can be electrically connected to battery connections 125 and 135 and to lower and upper lamps 111 and 112. The battery connections 125 and 135 can be exposed in a battery compartment 137 for making contact with a rechargeable battery 126. A battery compartment cover 128 can be provided for enclosing the rechargeable battery 126 in the battery compartment 137.

The control circuitry 136 can also be electrically connected to one or more solar panels 121. The solar panels 121 can convert light into an electric current, which can be provided to the control circuitry 136 for recharging the battery 126. The solar panels 121 can be attached to the upper surface of the upper housing shell 118. The upper housing shell 118 can include one or more holes through which wiring can pass allowing the solar panels 121 to be electrically connected to the control circuitry 136.

In some embodiments, the lighting device 100 can operate as an automatic dusk-to-dawn light fixture where the lower and upper lamps 111 and 112 automatically turn on and off depending on ambient light levels. In such embodiments, the control circuitry 136 can use the electrical current from the solar panels 121 to detect ambient light levels. The control circuitry 136 can turn on (illuminate) the upper and lower lamps 111 and 112 when the amount of light received by the solar panels 121 falls below a threshold switch-on value (e.g., at dusk); and the control circuitry 136 can turn off the upper and lower lamps 111 and 112 when the amount of light received by the solar panels 121 exceeds a threshold switch-off value (e.g., at dawn).

The upper lamp 112 is disposed in the upper light chamber 101 near the solar panels 121. As a result, light emitted by the upper lamp 112 is received by the solar panels 121. For this reason, the threshold switch-off value should be high enough that the light emitted by the upper lamp 112 does not cause the control circuitry 136 to turn off the upper and lower lamps 111 and 112. For example, if the control circuitry 136 is configured to turn on the lamps 111 and 112 at light levels of 70 Lux and turn off the lamps 111 and 112 at light levels of 110 Lux, the light emitted by the upper lamp 111 should be lower than 110 Lux. The threshold values of 70 Lux and 110 Lux are only examples and other Lux values can be used. For example, the switch-on value can be in a range of 12 Lux to 90 Lux, and the switch-off value can be in a range of 80 Lux to 180 Lux.

In place of, or in addition to, the automatic dusk-to-dawn functionality described above, the lighting device 100 can include a user-operable ON/OFF switch 123. In such embodiments, the control circuitry 136 can be electrically connected to the switch 123 such a user can operate the switch 123 to enable and disable operation of the lighting device 100.

As shown in the embodiment in FIG. 3, a number of optional decorative elements can be included with the lighting device 100. For example, the lighting device 100 can include upper and/or lower bezels 115 and 117 for covering at least an outer periphery of the circuit housing 103. An optional upper pinnacle 134 can be included, for example by attaching the upper pinnacle 134 to the upper lens 114 using a screw 133, which extends through an upper hole in the upper lens 114 and into an internally-threaded portion of the pinnacle 134. The upper hole can be at least substantially sealed, e.g., substantially water-tight or water-resistant, by a gasket 124 or the like.

The lower light chamber 102 can include a reflective element 119 secured to an inner bottom surface of the lower lens 116. The reflective element 119 can be configured for directing light from the lower lamp 111 towards the lower lens 116.

In the embodiment shown in FIG. 3, the lower lens 116 can be secured to a ground stake assembly so that the lighting device 100 can be configured for being secured to the ground, e.g., as a garden light. In such embodiments, the lower lens 116 can be supported by a lower collar 122, which is in turn connected to a pole 129 via a frictional connector 113. A ground stake 120 can be connected to a lower end of the pole 129.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, the “Summary” is not to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A lighting device, comprising:
a lower lens that allows at least a portion of impinging light to pass therethrough;
an upper lens that allows at least a portion of impinging light to pass therethrough;
a circuit housing disposed between the upper lens and the lower lens such that a lower light chamber is at least partially defined by the circuit housing and the lower lens, and an upper light chamber is at least partially defined by the circuit housing and the upper lens;
control circuitry at least partially disposed within the circuit housing;
an upper lamp electrically connected to the control circuitry for directing light into the upper chamber;
a lower lamp electrically connected to the control circuitry for directing light into the lower chamber; and
a solar panel exposed to the upper light chamber so as to receive light passing through the upper lens.

2. The lighting device of claim 1, further comprising battery connections for allowing at least one rechargeable battery to provide electrical power to the control circuitry, wherein the solar panel is operable for charging the rechargeable battery.

3. The lighting device of claim 2, further comprising a battery compartment including a cavity to receive the rechargeable battery such that the rechargeable battery can be electrically connected to said battery connections.

4. The lighting device of claim 1, wherein the circuit housing is substantially opaque.

5. The lighting device of claim 1, further comprising a switch operable to control said control circuitry.

6. The lighting device of claim 1, wherein the upper lamp includes a light emitting diode.

7. The lighting device of claim 1, wherein the lower lamp includes a light emitting diode.

8. The lighting device of claim 1, wherein the control circuitry turns on the upper lamp and the lower lamp when light received by the solar panel is below a threshold switch-on value and the control circuitry turns off the upper lamp and the lower lamp when light received by the solar panel is above a threshold switch-off value.

9. The lighting device of claim 8, wherein light emitted from the upper lamp and received by the solar panel is below the threshold switch-off value.

10. The lighting device of claim 1, further comprising a pole and a stake, the pole having an upper end connected to the lower lens and a lower end connected to the stake.

11. A lighting device, comprising:
a circuit housing comprising an upper housing shell and a lower housing shell;
control circuitry at least partially disposed within the circuit housing;
an upper lamp electrically connected to the control circuitry for directing light above the upper housing shell;
a lower lamp electrically connected to the control circuitry for directing light below the lower housing shell; and
a solar panel supported by the upper housing shell,
wherein the control circuitry turns on the upper lamp and the lower lamp when light received by the solar panel is below a threshold switch-on value and the control circuitry turns off the upper lamp and the lower lamp when light received by the solar panel is above a threshold switch-off value, and
wherein light emitted from the upper lamp and received by the solar panel is below the threshold switch-off value.

12. The lighting device of claim 11, further comprising battery connections for allowing at least one rechargeable battery to provide electrical power to the control circuitry, wherein the solar panel is operable for charging the rechargeable battery.

13. The lighting device of claim 12, further comprising a battery compartment including a cavity to receive the rechargeable battery such that the rechargeable battery can be electrically connected to said battery connections.

14. The lighting device of claim 11, wherein the upper lamp includes a light emitting diode.

15. The lighting device of claim 11, wherein the lower lamp includes a light emitting diode.

16. The lighting device of claim 11, further comprising an upper lens attached to the upper housing shell, the upper lens being configured to allow at least a portion of light emitted by the upper lamp to pass therethrough.

17. The lighting device of claim 11, further comprising a lower lens attached to the lower housing shell, the lower lens being configured to allow at least a portion of light emitted by the lower lamp to pass therethrough.

18. The lighting device of claim 17, further comprising a pole and a stake, the pole having an upper end connected to the lower lens and a lower end connected to the stake.

19. The lighting device of claim 11, wherein the circuit housing is substantially opaque.

20. The lighting device of claim 11, further comprising a switch operable to control said control circuitry.
